(19) United States
(12) Patent Application Publication
(10) Pub. No.: US 2021/0337825 A1
(43) Pub. Date: Nov. 4, 2021

(54) Taste Enhanced Candy Configuration

(71) Applicant: Chuck Block, San Diego, CA (US)

(72) Inventor: Chuck Block, San Diego, CA (US)

(21) Appl. No.: 17/244,503

(22) Filed: Apr. 29, 2021

Related U.S. Application Data
(60) Provisional application No. 63/017,397, filed on Apr. 29, 2020.

(51) Int. Cl. A23G 3/54; A23G 3/34

(52) U.S. Cl. CPC A23G 3/54; A23G 3/0065

(57) ABSTRACT

A taste enhanced candy piece is formed by a first candy section which is in an engagement to a second candy section. The candy piece has three taste areas for a user, and each can impart a different candy taste. Sweet or sour candy material may form either of the candy sections and either candy section may be formed of soft candy material or hard candy material.

This application claims priority to U.S. Provisional patent application Ser. No. 63/017,397 filed on Apr. 29, 2020, which is incorporated herein in its entirety by this reference thereto.

### BACKGROUND OF THE INVENTION

### 1. Field of the Invention

The invention herein disclosed relates generally to confectionaries such as candy. More particularly, it relates to a two-piece candy configuration allowing for the inclusion of multiple types of candy in the same candy piece, as well as the adjustment of the overall taste of the candy perceived by the person eating it through the adjustment of the exterior surface area of the two candy components forming the single candy piece, which are formed of candy materials of differing individual taste.

### 2. Prior Art

### BACKGROUND OF THE INVENTION

Candy has been a favorite treat of both adults and children for centuries and continues to provide gustatory delight to those who eat it.

In humans, what is conventionally called a gustatory sense or a sense of taste is derived from signals sent to the brain from a plurality of sensory cells positioned on the surface of the tongue. Research has found that the sense of taste of a person is based on the information which is communicated over the nervous system from the tongue to the brain. Modern research on the subject indicates there are at least five basic qualities of taste. These include sweet, sour, salty, bitter, and savory.

While it was once thought that there were separate sensory cells or taste buds located on the tongue in differing areas, which specialized in sensing these individual qualities, modernly such has been found not to be the case. Instead, it has been found that the taste perceived by the brain of a person is essentially a blend of the five qualities of taste which are perceived by all of the sensory cells on the tongue concurrently. Thus, a perceived taste of candy, as conventionally produced, may be a combination of multiple signals from sensory cells indicating sweet and sour foods in contact with the tongue.

With respect to the above, before explaining at least one preferred embodiment of the candy configuration herein, it is to be understood that the system invention is not limited in its application to the details of employment and to the arrangement of the components or the steps set forth in the following description or illustrated in the drawings. The various apparatus and methods and steps of the herein disclosed candy configuration of sections is capable of other embodiments and of being practiced and carried out in various ways. All of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other entertaining and educational candy container systems. It is important, therefore, that the embodiments, objects, and claims herein, be regarded as including such equivalent construction and methodology insofar as they do not depart from the spirit and scope of the present invention.

### SUMMARY OF THE INVENTION

The disclosed candy device herein, provides a candy piece device and a method of forming such into a single unit with multiple exterior surface areas from a plurality of individual candy sections. The external surface areas of each section forming the single unit candy piece is adjusted for surface areas thereon. This formation thereby adjusts the surface area and shape of each individual candy section, which, when placed in the mouth, communicates with the taste sensory cells positioned about the surface area of the tongue of a user.

The candy piece, so formed, may be a combination of two or more different types of candy with differing sensed tastes which are formed to a unitary structure into a single candy piece. For example, one candy section may be a hard candy which is formed of candy material which, when it contacts the sensory cells of the tongue, has either a sweet or tart or sour taste.

The second candy section engaged to the first candy section can be, for example, a compressible or softer candy section formed of compressed dextrose with a fruit or other sweet flavor, which dissolves faster within the mouth than a conventional hard candy. Of course, the plurality of candy sections may be more than two, where each has a differing sensed flavor from the above noted group of five such flavors, and where each section, engaged to the final structure, has an intentionally calculated exposed surface area and shape, which will contact the tongue's sensory cells in relation to the surface areas of the others.

In the industry, one manner of conventional hardness of candy applies names to different types of hard and soft candy such as a Thread, a Soft ball, a Firm ball, a Hard ball, a Soft crack, a Hard crack, and a Caramel. The different hardness is achieved by heating the liquid candy solution having sucrose or another sweetener and flavorings to sequentially increasing temperatures. However, this is somewhat subjective and a better manner to measure relative hardness of the candy section is by durometer using a conventional deflection measuring device and durometer scales.

By the term hard candy, as used herein, is meant that the formed candy section has a Shore A hardness of substantially in the range of shore A hardness of 71-100. For example, a hard candy such as a lollipop would be toward a shore A hardness of 90 and slightly softer hard candies would be below that level.

By the term soft candy, as used herein, is meant the candy section has a shore A hardness substantially in the shore A hardness range of 10-70. Thus, a gummy candy would have a shore A hardness of 10 and a harder caramel may be in the Shore A 50 range. Shore hardness can be measured using any type of conventional measuring tool which measures the deflection of the candy section.

Regarding the terms of taste, by the term sour, as herein used, is meant the solution forming the candy has a pH level between 1.6 and 3.1. For example, a tangy candy will typically have a pH around a 3 to a 2.5 in this range. Candies perceived as being more sour will measure around 1.8 to 1.6 in the range of pH noted above.

Sweetness is commonly measured by comparisons of taste testers to reference solutions of sucrose. Sucrose (sugar) is the standard to which all other sweeteners are compared. It is known that humans can recognize sweetness of about 1% or 2% sucrose in the total volume of a liquid or solid solution. For example, coffee is typically sweetened to about the level of 5% sucrose by liquid volume and many soft drinks are about as sweet as 10% sucrose by liquid volume. A 15% sucrose level, in a solution, is perceived as extremely sweet and starts to feel a little syrupy to a human tasting it. Taste panelists are often trained to quantitate sweetness on a 15 cm line scale, for convenience, using 2% as the lowest amount of sensed sweetness and 15% sucrose by volume in the solution as the sweetest taste.

Therefore as used herein, the term sweet means that the solid solution forming the candy section is between 2-15% sucrose by volume.

Charts exist as to other sweeteners such as corn syrup and their relative sweetness as compared to sucrose. If another sweetener is employed, the conventional ratio of the amount of such a different sweetener by volume as compared to sucrose should be employed. For example, fructose is known to be 30% sweeter than sucrose, so the percentage of fructose in the same volume of a liquid or solid solution of fructose would 77% of the amount of sucrose in the same volume of solution to achieve the same sweetness level.

In addition to adjusting the sweetness and sourness of the formed candy herein, the maker of the candy using two or more candy sections, can adjust which candy flavor is to be imparted overall to the sensory cells of the tongue of a person eating or sucking on the candy, and the intensity sensed by the brain of the user by adjusting the area and shape of the exterior surface area of each candy section relative to the other. For example, for a candy piece which is to impart a sweeter perceived taste to the person eating it, but still provide a tart, sour, or other perceived flavor aspect, the surface area of the candy section formed of sweeter more sugary material would be formed to have an exterior surface area and shape which contacts with the sensory cells of the tongue, which exceeds surface area of the second candy section formed of sour or other flavored material.

When the candy is moved about the mouth and different areas contacted by the sensory cells of the tongue, the component with the larger surface area will contact more sensory cells. Further, the combination of two or more tastes, from the plurality of materials forming the candy, insures that the eating user does not become numb to the taste of either individual section since the sensory cells of the tongue continually contact against different surfaces with differing tastes to allow the brain to continuously discern different flavors from each area.

Further adjustments to the perceived flavor of the person consuming the candy piece can be provided by adjusting the shape and contour of the exposed exterior surface area of each of the candy sections forming the candy structure. For example, experimentation has shown that forming a depressed curve in a larger surface area of one candy section or in between two sections has been found to provide significantly increased contact of the larger curved surfaces thereof with the sensory cells of the tongue. This is apparently because the depressed area matches the curve of the tongue surface, or the tongue of the user is attracted to and contacts the depressed area. Further experimentation has shown that people sucking on the individual candy tend to move it about and continuously position their tongue into such depressions. Conversely, forming a projecting curved portion on the surface area of a candy section can lessen the perceived flavor thereof to the sensory cells of the tongue.

Consequently, in making the candy piece of a plurality of candy sections each formed of a differing flavored candy material, the system and candy herein will have the candy maker adjust the size and exterior surface area contacting the tongue of each candy section relative to the other to thereby adjust the perceived taste sensed by the person eating it. Further sensory adjustments can be made by shaping the candy sections into concave and projecting curved surface areas and by making an area of one curved surface descending into a recessed area larger than an opposing surface area on the opposite side of the recess.

For example, making the radius of the curve of a first candy portion on one side of the formed recess larger than that of the second candy portion on the opposite side of the recess. This configuration positions a larger surface area of the first candy portion exposed to the sensory cells of the tongue positioned within the recess.

Finally, because hard candy tends to last longer in the mouth as compared to a soft or compressed powdered candy, the overall volume of one candy section to the other can also be adjusted to adjust the perceived flavor over the duration of time the candy is in contact with the tongue. Soft candy material which dissolves faster, such as a compressible or gummy soft candy may be formed in a first candy section, which by volume exceeds that of the second candy section forming the single candy piece. Thus, the faster dissolving candy section exposes the sensory cells to a larger amount of flavor from that section, and that flavor lasts essentially for the duration of time the candy dissolves since the faster dissolving section is larger and lasts as long as the slower dissolving section.

However, maintaining a connection between such candy sections of differing hardness and rate of dissolving was initially found to be an issue during testing and experimentation. It was found over time that engagement between the two candy sections may be maintained for the duration of dissolving by using edible adhesive in most instances. However, a much better connection was found in experimentation where the first candy section has a projection adapted to engage and hold a second candy section engaged around and on the projection. Consequently, such would be preferred to maintain the two candy sections engaged during consumption. In this mode, a preformed first candy section is brought together with a preformed second candy section and they are mechanically engaged. For example, a soft candy section is pushed toward the hard candy section having the projection, and a cavity in the soft candy section momentarily stretches over the larger distal end of the projection, and then contracts to hold it in place.

With respect to the above candy configuration description, before explaining at least one preferred embodiment herein, it is to be understood that the invention is not limited in its application to the details of operation nor the arrangement of the components or the steps set forth in the following description or illustrations in the drawings. The various methods of implementation of the optimized candy configuration herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other methods and systems for carrying out the several purposes of forming a candy with sections thereof optimized for an intended taste. Therefore, the objects and claims herein should be regarded as including such equivalent construction, steps, and methodology insofar as they do not depart from the spirit and scope of the present invention.

It is an object of this invention to provide candy in pieces, which are configured from a plurality of sections, where the sections are formed of differing candy confection materials to thereby enhance and provide a customized taste to the user eating it.

It is an additional object to provide such a candy formed of components or sections, wherein the exterior surface area of each candy section is adjusted, relative to the other, to increase the surface contact area of one section with the tongue, over the other to thereby adjust the overall perceived flavor experienced by the person consuming it.

It is a further object of this invention to provide such an enhanced candy piece where a curved depression formed on opposite sides by a first candy and second candy continuously exposes the taste cells to continuously differing sensed flavors.

These, together with other objects and advantages which become subsequently apparent, reside in the details of the construction and configurations of the candy herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 depicts a perspective view of a mode of the candy piece, herein, showing a first candy section formed of a first candy material and a second candy section formed of a second candy material.

FIG. 2 shows a side view of the candy device of FIG. 1.

FIG. 2A shows the candy device wherein a diameter of the second section is larger than the diameter of the first section to which it is engaged.

FIG. 2B shows the candy device wherein a diameter of the second section is smaller than the diameter of the first section to which it is engaged.

FIG. 3 depicts an example of another mode of the candy device of FIG. 1, wherein the exterior surface area of the candy section formed of one candy material exceeds the surface area of the second candy material.

FIG. 4 shows a sectional view through FIG. 3 showing that, internally, the candy section having the smaller exterior surface area forms a center of the candy piece.

FIG. 5 shows a mode of the candy piece device, herein, showing the exposed external surface area of one section of the candy piece is formed substantially larger than that of the other, thereby increasing contact thereof with the taste sensory cells on the tongue.

FIG. 6 depicts the candy piece herein having two sections showing a first tasting area, a second tasting area, and a third tasting area provided by the candy piece in a two section configuration.

### DETAILED DESCRIPTION OF THE PREFERRED EMBODIMENTS OF THE INVENTION

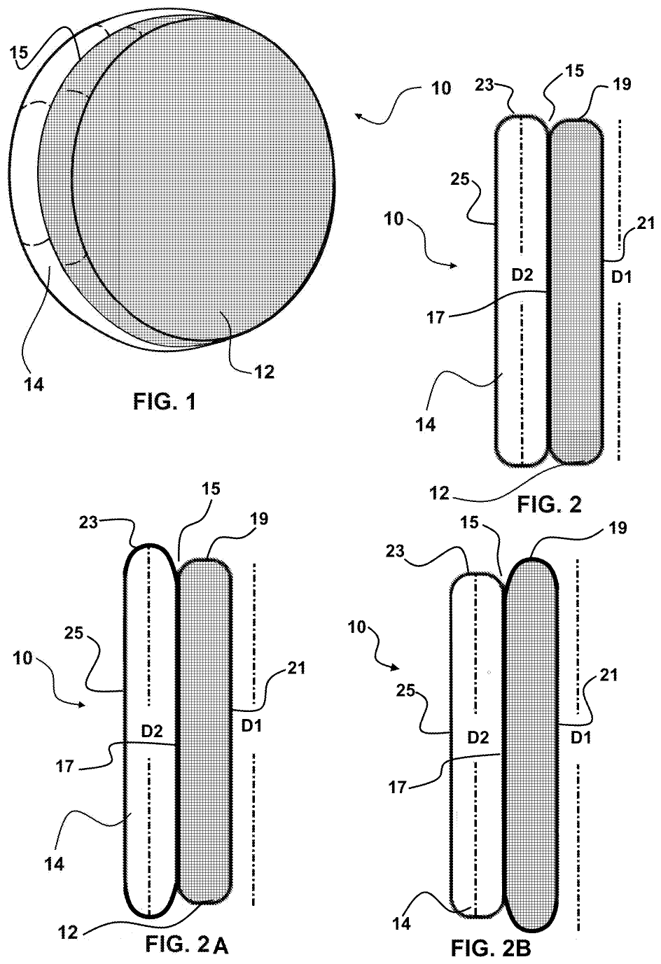

Referring now to the candy piece 10 herein shown in simple format by the depictions of FIGS. 1-6, there is seen in FIG. 1 the candy piece 10 which is formed to a singular structure from a plurality of candy sections, shown as a first candy section 12 and a second candy section 14. While shown as round sections and candies, the candy may also be shaped in other fashions such as rectangular or oval. However, currently oval or round candy pieces 10 formed of oval or round sections are preferred as such eliminates rough edges. As such, by the term round, as used herein, is meant generally circular and including both oval and round shapes.

As shown in FIG. 1, the candy piece 10 is formed of a first candy section 12 and a second section 14 which are engaged along one side surface of each. Where the diameter of the first candy section 12 is adjusted to be larger or smaller than that of the second section 14 to adjust the surface area of each which is exposed to the tongue of the user, which would have substantially equal widths running perpendicular to the respective diameter.

As shown in FIG. 2, the candy piece 10 is round and has a first candy section 12 which has a first diameter D1 and the second candy section 14 has a second diameter D2 which is substantially equal to the first diameter D1. In this mode, the respective exterior first surface or tasting area 31 (FIG. 6) of the first candy section 12 and the second tasting area 33 (FIG. 6) of the second candy section 14, which is exposed to the taste sensors in the tongue of a user, would be substantially equal. A third tasting area 35 (FIG. 6) is formed in the recess 15 there between and would expose the user to an equal area of the first tasting area 31 and the second tasting area 33 in a combination to different taste sensors of the tongue positioned in the recess 15.

While the exterior circumferential surface of the engaged first candy section 12 and second candy section 14 can be planar and form a planar circumference at the intersection with the contact line 17 of the formed candy piece 10, it is preferred that circumferential recess 15 is formed in a central area of the formed candy piece 10. Such a recess 15 is shown as aligned with the facing surfaces of each candy section along a contact line 17 where they contact each other. This recess 15 is preferred because it gives the user eating the candy piece 10 the, herein noted, three tasting areas to taste three flavors of the formed candy piece 10.

The first tasting area 31 for tasting is defined by the exterior surface of the first candy section 12, which extends from the intersection of the exterior surface at the center line 17 and around a first exposed surface 21 of the first candy section 12. The second tasting area 33 for tasting is defined by the second exterior surface of the second candy piece 14, which extends upon the exterior surface from the center line 17 and around the second exposed surface 25 of the second candy section 14.

The third tasting area 35 for flavor tasting is defined by the surface of the exterior of both the first candy section 12 and second candy section 14, which is positioned on opposing sides of the recess 15. In this third tasting area 35, the tongue and taste sensors thereon of a user will contact against respective portions of both the first candy section 12 and second candy section 14 concurrently and provide a completely different sensed taste which is a combination of the taste of the candy forming the first candy section 12 and second section 14. For example, the first candy section 12 can be formed with sour candy material, as noted above, and the second candy section 14 can be formed of sweet candy material, as noted above.

While shown as curving portions of both the first candy section 12 and second candy section 14 which are positioned on opposing sides of the recess 15 and which slant downward toward the connecting line 17, these facing portions can also be planar or linear. As noted, such a recess 15 tends to attract contact by a tongue of a user eating candy and the manufacturer count on such and thereby can adjust the sweetness and sour nature of the solid solution forming each of the first candy section 12 and second candy section 14 to combine in the third tasting area 35 in the recess 15 and provide the user with a completely different taste of flavor than that of either of the first candy section 12 or second candy section 14.

In FIG. 2A is shown the candy piece 10 wherein the diameter D1 of the candy section 12 is smaller than the diameter D2 of the second candy section 14. This configuration allows the manufacturer to take into consideration the larger second tasting surface area 33 for tasting the flavor provided to the second candy section 14. This configuration, as shown, also includes the preferred recess 15 forming the third tasting area 35 for tasting.

In FIG. 2B is shown the candy piece 10 wherein the diameter D2 of the second candy section 14 is smaller than the diameter D1 of the first candy section 12. This configuration allows the manufacturer to take into consideration the larger first tasting area 31 for flavor tasting provided to the larger exposed area of the first candy section 12. This configuration, as shown, also includes the preferred recess 15 forming the surface of the third tasting area 35 for tasting.

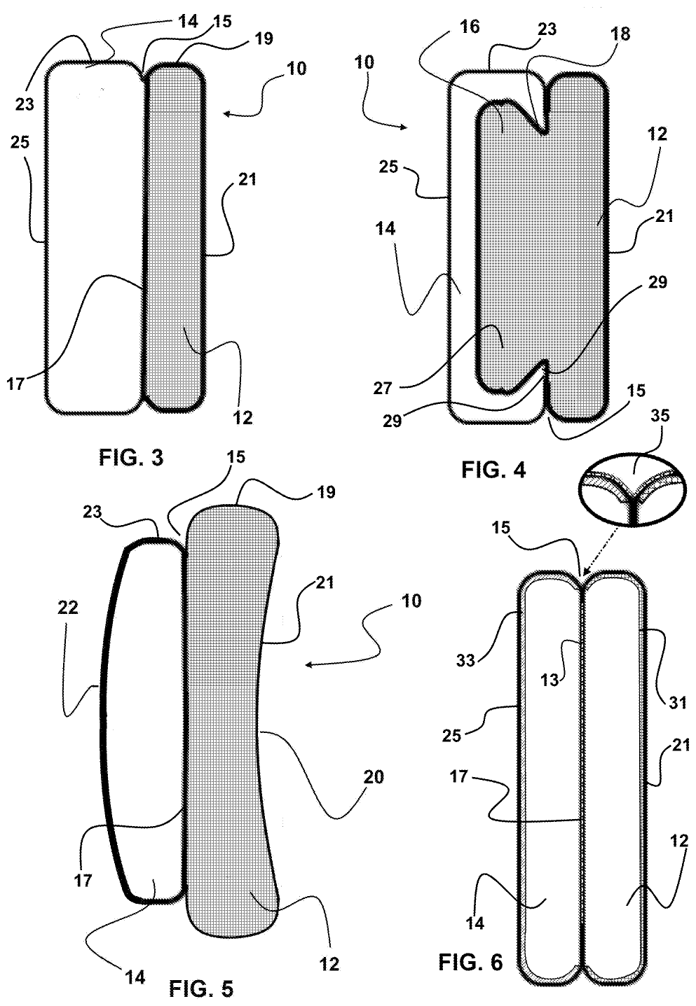

Shown in FIG. 3, the width of the second candy section 14 which runs along a line perpendicular to the contact line 17 which intersects the second exposed surface area 25, of the second candy section 14, is substantially twice the width of the first candy section 12 which extends from the contact line 17 to the first exposed surface 21. In this mode, the area of the second exposed surface 25 and the first exposed surface 21 are substantially equal. However, the area of the circumference 23 extending from the contact line 17 to the second exposed surface 25 is twice that of the area of the circumference 19 of the first candy section 12. The ratio of the circumferential side surfaces 19 of the first candy section 12 to the circumference side 23 of the second candy section 14 can be adjusted by the maker, in order to change the perceived flavor of the candy, when exterior areas of the two sections come in contact with sensory cells on the tongue. As can be seen, the recess 15 has equal areas of the surfaces of the first candy section 12 and second candy section 14 forming the third tasting area 35.

In all modes of the device herein, the first candy section 12 and second candy section 14 are in an engagement, such as along contact line 17. By the term engagement is meant either an adhesive engagement or a mechanical engagement such as by a first formed connector on the first candy section 12 with engages with a complimentary second formed connector on the second candy section 14.

Such an adhesive engagement may be formed by an edible adhesive 13 (FIG. 6) such as tylose glue, sugar, or other conventional edible adhesive, in a contact, such as along the contact line 17, between exterior surfaces of the first candy section 12 and second candy section 14, such as shown in FIGS. 2-3, 5-6. In many cases, the sucrose or sugar contained in one or both of the first section 12 and second section 14 can provide the edible adhesive 13.

However, a more preferred mode of such an engagement, which works no matter the material content of either of the first candy section 12 and second candy section 14, is a mechanical engagement such as having a projecting portion 16 from one of the first candy section 12 or second candy section 14. As shown herein, the first candy section 12 formed with the projecting portion 16 having a larger diameter at the distal end 27 than the diameter of an annular other recess 18 therearound which is formed adjacent the body of the first candy section 12. This mechanical engagement has shown to be more fixed and less likely to separate when the formed candy piece 10 is exposed to the tongue and saliva of the mouth of the user and maintains the third tasting area 35 intact longer and generally for the entire duration of eating of the candy piece 10.

Such may be accomplished, for example, by forming the first candy section 12 of a hard candy and positioning the projecting portion 16 through an opening 29 of a softer candy forming the second candy section 14. Such allows the softer candy forming the second candy section 14 to temporarily expand and then contract into the recess 18, to a final form, and thereby hold the second candy section 14 engaged with the first candy section 12. Once so engaged, the material of the second candy section 14 is locked in an engagement with the projecting portion 16 of the first candy section 12 as in FIG. 4.

Shown in FIG. 5 is an example where the first tasting area 31 formed on the first candy section 12 is substantially increased over the second tasting area 35 of the second candy section 14. As noted, this will cause more surface area of the first candy section 12 to contact sensory cells of the tongue, and increase the brain's perception of the flavor of the first candy section 12, when combined with the flavor sensed by the sensory cells from the lessor exterior surface area of the second candy section 14.

An adjustment to this contact with tongue sensory cells, as noted above, can also be achieved by forming exterior surface areas of one of the candy sections in a curved or other large depression 20 to increase the first exposed surface area 21 which may contact with tongue sensory cells or a projecting curve 22 to decrease the contact with tongue sensory cells.

Shown in FIG. 6, is a two section candy piece 10 with a recess 16 therebetween which extends completely around the circumference of the candy piece 10 substantially along the contact line. As depicted, FIG. 6 shows examples of the formed first tasting area 31, a second tasting area 33, and a third tasting area 35 which combines the tastes of the first tasting area 31 and second tasting area 33 but on opposite sides of the recess 15, so that the user will taste both flavors in a combination touching different sensory positions on their tongue. While not depicted, if a third candy section is engaged to the first two, a fourth tasting area would be positioned in the recess between the adjacent candy section to with the third candy section is engaged along a common contact line.

While all of the fundamental characteristics and features of the candy piece formation for adapting sensed flavor have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A taste enhanced candy piece, comprising:
a first candy section;
a second candy section;
a second side of said first candy section in an engagement with a second side of said second candy section along an engagement line;
said first candy section having a first tasting area formed on a first exposed exterior surface, said first exposed exterior surface including a first side of said first candy section opposite said second side thereof, and an area extending from said first side to an intersection of said engagement line at a first exterior circumference of said first candy section;
said second candy section having a second tasting area formed on a second exposed exterior surface, said second exposed exterior surface including a first side of said second candy section opposite said second side thereof, and an area extending from said first side of said second candy section to an intersection of said engagement line at a second exterior circumference of said first candy section;
a recess formed circumferentially around said taste enhanced candy piece;
a third tasting area, said third tasting area defined by a portion of said first exposed exterior surface located on one side of said recess and a portion of said second surface which is located on an opposite side of said recess from said first exposed exterior surface.

2. The taste enhanced candy piece of claim 1, additionally comprising:
one of said first candy section or said second candy section being hard candy; and
the other of said first candy section or said second candy section being soft candy.

3. The taste enhanced candy piece of claim 1, additionally comprising:
one of said first candy section or said second candy section being formed of sour candy material; and
the other of said first candy section or said second candy section being formed of sweet candy material.

4. The taste enhanced candy piece of claim 3, additionally comprising:
one of said first candy section or said second candy section being formed of sour candy material; and
the other of said first candy section or said second candy section being formed of sweet candy material.

5. The taste enhanced candy piece of claim 1, wherein said engagement of said second side of said first candy section with a a second side of said second candy is formed of edible adhesive.

6. The taste enhanced candy piece of claim 2, wherein said engagement of said second side of said first candy section with a a second side of said second candy is formed of edible adhesive.

7. The taste enhanced candy piece of claim 3, wherein said engagement of said second side of said first candy section with a a second side of said second candy is formed of edible adhesive.

8. The taste enhanced candy piece of claim 4, wherein said engagement of said second side of said first candy section with a a second side of said second candy is formed of edible adhesive.

10. The taste enhanced candy piece of claim 1, wherein said engagement of said second side of said first candy section with a a second side of said second candy comprises:
a projection extending from one of said second side of said first candy section or said second side of said second candy section; and
said projection engaged with an opening formed on the other of said second side of said first candy section or said second side of said second candy section.

11. The taste enhanced candy piece of claim 2, wherein said engagement of said second side of said first candy section with a a second side of said second candy comprises:
a projection extending from one of said second side of said first candy section or said second side of said second candy section; and
said projection engaged with an opening formed on the other of said second side of said first candy section or said second side of said second candy section.

12. The taste enhanced candy piece of claim 3, wherein said engagement of said second side of said first candy section with a a second side of said second candy comprises:
a projection extending from one of said second side of said first candy section or said second side of said second candy section; and
said projection engaged with an opening formed on the other of said second side of said first candy section or said second side of said second candy section.

13. The taste enhanced candy piece of claim 4, wherein said engagement of said second side of said first candy section with a a second side of said second candy comprises:
a projection extending from one of said second side of said first candy section or said second side of said second candy section; and
said projection engaged with an opening formed on the other of said second side of said first candy section or said second side of said second candy section.

14. The taste enhanced candy piece of claim 1, additionally comprising;
a recess formed into one of said first side of said first candy section or said first side of said second candy section.

15. The taste enhanced candy piece of claim 2, additionally comprising;
a recess formed into one of said first side of said first candy section or said first side of said second candy section.

16. The taste enhanced candy piece of claim 3, additionally comprising;
a recess formed into one of said first side of said first candy section or said first side of said second candy section.

17. The taste enhanced candy piece of claim 4, additionally comprising;
a recess formed into one of said first side of said first candy section or said first side of said second candy section.

18. The taste enhanced candy piece of claim 8, additionally comprising;
a recess formed into one of said first side of said first candy section or said first side of said second candy section.

19. The taste enhanced candy piece of claim 13, additionally comprising;
a recess formed into one of said first side of said first candy section or said first side of said second candy section.
